(19) United States
(12) Patent Application Publication
(10) Pub. No.: US 2025/0324948 A1
(43) Pub. Date: Oct. 23, 2025

(54) AUTOMATED MOBILITY SCORING OF FARM ANIMALS

(71) Applicant: Iowa State University Research Foundation, Inc., Ames, IA (US)

(72) Inventors: Santosh Pandey, Ankeny, IA (US); Jan Shearer, Ankeny, IA (US); Leslie Shearer, Ankeny, IA (US); Paul Plummer, Sevierville, TN (US); Yunsoo Park, Ames, IA (US); John H. Wagner, Cedar Falls, IA (US); Juan P. Steibel, Ames, IA (US)

(73) Assignee: Iowa State University Research Foundation, Inc., Ames, IA (US)

(21) Appl. No.: 19/183,108

(22) Filed: Apr. 18, 2025

Related U.S. Application Data
(60) Provisional application No. 63/636,414, filed on Apr. 19, 2024.

(51) Int. Cl. A01K 29/00; A01J 5/007; A01K 1/12; G06T 7/00; G06T 7/70; G06V 10/82; G06V 40/10; G06V 40/20; H04N 23/90

(52) U.S. Cl. CPC A01K 29/005; G06T 7/0012; G06T 7/70; G06V 10/82; G06V 40/10; G06V 40/25; H04N 23/90; A01J 5/007; A01K 1/126; G06T 2207/10016; G06T 2207/20084

(57) ABSTRACT

A system for evaluating lameness of animals is provided. In the system, one or more imaging devices are configured to capture a recording of an animal walking or standing from a profile view, an anterior view, or a posterior view. A computing device is in communication with the one or more imaging devices, and the computing device is configured to access an artificial intelligence model to analyze the recording to assign a lameness score to the animal. The computing device then outputs the lameness score to a user. In addition, pressure-sensing mats with force plates are configured to measure the leg weight bearing and total body weight of animals to track fluctuations in body weight and leg strength. Also disclosed are a method of identifying lameness in an animal and a mobile application that implements the method.

### CROSS-REFERENCE TO RELATED PATENT APPLICATIONS

This patent application claims the benefit of U.S. Provisional Patent Application No. 63/636,414, filed Apr. 19, 2024, the entire teachings and disclosure of which are incorporated herein by reference thereto.

### STATEMENT REGARDING FEDERALLY SPONSORED RESEARCH AND DEVELOPMENT

This invention was made with government support under 2023-68008-39857 awarded by the U.S. Department of Agriculture National Institute of Food and Agriculture. The government has certain rights in the invention.

### FIELD OF THE INVENTION

This invention generally relates to a method and system for evaluating the lameness of cows in a herd and, in particular, to a method and system that utilizes artificial intelligence and force plate sensors to track the gait, posture, and leg weight bearing of an animal, such as a cow, to evaluate lameness and body weight fluctuations.

### BACKGROUND OF THE INVENTION

The world's population is projected to increase to 9.9 billion by 2050, posing important challenges towards achieving the United Nation's Sustainable Development Goals. One Grand Challenge for our society lies in preserving and improving our planet's food resources, including animal-sourced food. Milk and dairy products have a high nutrient content with links to multiple health benefits. As dairy cattle age or when milk yield decreases, they are harvested for beef-a widely consumed protein food source worldwide that supports cognitive child development and overall human health. Data indicates that the US milk production in 2021 was around 226 billion pounds for the 9.37 million dairy cows. However, the dairy and beef industries are strained by an acute shortage of skilled labor, rising costs of feedstuffs and feed supplements, concerns in meat processing capacity, and global macroeconomics. Hence, it is desirable to address these challenges, at least in part, through the deployment of automated monitoring technologies that have significant potential to identify and address issues in animal health and well-being. Lameness management is one such area of critical need that starts with the identification of early signs of lameness in farm animals, followed by prompt treatment.

Lameness in dairy cattle is a painful condition associated with foot and hoof diseases—the top three are digital dermatitis, sole ulcers, and foot rot. Lame cows exhibit a progressive reduction in feeding/drinking activity, and milk production, and may have difficulty standing/walking or interacting with herd mates. Previous studies have indicated that the prevalence of lameness in US dairy farms could range from 10% to 55%. Assuming a mean prevalence of lameness of 25% for the 9.37 million dairy cows currently in the United States (US), this suggests that potentially 2.35 million cows will suffer from lameness, which will cost approximately $418 million to the US dairy industry (based on estimated mean cost of lameness of around $178 per case). This would make lameness the costliest clinical disease of dairy cattle and one of the most important health and welfare issues identified by dairy producers. If intervention is delayed, lameness may progress to a more severe condition, resulting in the need to euthanize affected animals. Timely identification of lameness is necessary to institute early treatment, reduce the use of antibiotics, and improve treatment outcomes.

Lameness management is a constant battle for all stakeholders (owners, producers, farm employees, and veterinarians) in most dairy operations. While lameness is not often a direct cause of cow death, lameness degrades the ambulatory status of the animal resulting in euthanasia and culling. A survey by the USDA National Animal Health Monitoring System reported that 20% of dairy cow deaths in the US resulted from euthanasia and were attributed to lameness or injury. It is often difficult to pinpoint the exact cause of lameness, which may be linked to a multitude of factors on the farm, such as nutrition, feedstuffs and supplements, cow comfort, bedding, heat stress or infrequent foot care.

Body weight loss is a known risk factor for lameness. Monitoring body weight fluctuations over time can be used to assess evidence of negative energy balance in cows, evidence of disease or recovery from an illness. Commercial weight scales for animals are only designed to measure the total body weight of an animal, and not the weight bearing of each leg. Commercial weight scales for animals are very expensive, bulky and infeasible for frequent weight measurements of many animals in farms. Routine monitoring body weight and weight bearing of each leg of cows using a portable, light-weight, and cost-effective system can be a valuable tool to track lameness or illness particularly for robotic dairies, but also larger dairies with different milking systems.

Currently, dairy farms rely on visual observation by farm employees to identify lame cows. The ID of each lame cow is entered into the farm database, and those cows are separated from the herd and put into the lame cow pen. However, it is challenging to identify all cows with abnormal gait in a herd by visual observation alone, especially in large-scale dairy farms having thousands of cows. Further, mobility scoring is subjective and tedious, and discrepancies frequently result between and within observers. In most studies that use mobility scoring, mildly lame cows are included in the non-lame cow group, which limits the possibility of early detection and of prompt treatment of lameness cases. It is well documented in several studies that most producers underestimate the prevalence of lameness in their herd by a factor of four or more compared with trained observers. Furthermore, with increasing costs of farm operations and a shortage of skilled labor, it is difficult to recruit and retain trained farm workers who are skilled at identifying early signs of lameness. These bottlenecks contribute to a significant delay from lameness detection to foot care treatment, which results in deteriorating health and welfare conditions for the lame cow while putting economic and regulatory pressures on the producers.

### BRIEF SUMMARY OF THE INVENTION

In view of the foregoing deficiencies, embodiments of the present disclosure relate to a mobile-friendly, farm-deployable digital technology for lameness detection. To address the critical bottlenecks in visual scoring of lameness, Applicant has developed and expects to deploy and disseminate imaging and sensing technologies for the automated identification of animal lameness. In one or more embodiments, the imaging technology comprises an imaging electronic device, computing device, data analytics platform, and methods as described herein. According to aspects, the imaging electronic device is a mobile video recording device (such as a smartphone) that is securely positioned to record videos or images of walking or standing animals. The imaging electronic device is positioned at specific locations, such as the entrance or exit of a milking parlor, on a milking parlor, at a loading or unloading ramp, a hospital barn or pen, a maternity barn, or a lame cow pen. Embodiments of the presently disclosed technology are expected to deliver an objective tool for lameness assessment, which will facilitate prompt identification and treatment of lame animals, streamline farm lameness management strategies, improve animal welfare, and promote farm sustainability. Applicant expects that the disclosed technology will be integrated with extension activities (such as the Master Hoof Care Technician Program) to disseminate tools for farm employees and improve their digital literacy in lameness identification.

In a first aspect, embodiments of the disclosure relate to a system for evaluating lameness of animals. The system includes one or more imaging devices. Each imaging device is configured to capture a recording of an animal walking or standing from a profile view, an anterior view, or a posterior view. A computing device is in communication with the one or more imaging devices, and the computing device is configured to access an artificial intelligence model to analyze the recording to assign a lameness score to the animal. The computing device outputs the lameness score to a user.

In a second aspect, embodiments of the disclosure relate to a method for identifying lameness in an animal. In the method, a video recording of an animal walking or standing is obtained. The video captures a profile view, a posterior view, or an anterior view of the animal. The video recording is analyzed using an artificial intelligence model to identify a plurality of body parts of the animal. One or more of the plurality of body parts of the animal is tracked over a length of the video recording so as to compute a position of each of the one or more of the plurality of body parts in each frame of the video recording. At least one of a gait parameter or a posture parameter is calculated based on the tracking of the one or more of the plurality of body parts, and a lameness score is assigned to the animal based on at least one of the gait parameter or the posture parameter.

In a third aspect, embodiments of the disclosure relate to a non-transitory, machine-readable storage medium for a mobile device. The mobile device includes memory and a processor. The memory is configured to store program code, and the processor is configured to execute the program code to perform a method for identifying lameness in an animal according to the second aspect.

In a fourth aspect, embodiments of the disclosure relate to a method for identifying lameness in an animal. In the method, individual force plates are positioned on the floor of the milking stall to measure the weight bearing of at least two, preferably all four, animal hooves and, preferably, the total body weight. Each force plate consists of a plurality of load cells or strain gauges to record the applied weight bearing. In one or more embodiments, the force data is sent to a data converter and a microprocessor and then transmitted to a computing device. In milking parlors, four force plates (for recording weight bearing on each hoof and total body weight) or two force plates (preferably for recording the weight bearing on the hind hooves) could be used to identify the lame foot during the milking operation. The sampling rate can be 0.1 millisecond to 1 second over the typical six to seven minutes duration of milking. In cows, nearly 80% of lameness occurs in the hind legs so monitoring the weight bearing of the hind legs is found to be sufficient to detect lameness in low-resource settings. However, monitoring the weight bearing of all the four legs would provide a comprehensive view of leg strength of the animal and the total body weight for data analysis on every animal. Fluctuations in the total body weight may be indicators of lameness, malnutrition, or illness.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1A depicts a rotary milking parlor including a plurality of imaging devices for capturing recordings of an animal walking or standing, according to an exemplary embodiment;

FIG. 1B depicts a milking stall including a plurality of imaging devices and force plate sensors positioned to capture various aspects of an animal standing during milking, according to an exemplary embodiment;

FIG. 2 is a flow diagram of a method for developing an artificial intelligence model for identifying lameness in an animal, according to an exemplary embodiment;

FIGS. 3A-3C are (A) a picture of a cow with several identified landmarks tracked by the artificial intelligence model, (B) synthetic data of using randomly added obstructions to train the A.I. model to track the landmarks despite the obstructions, and (C) real-word identification of cows in an image despite obstructions, such as railings, according to an exemplary embodiment;

FIG. 4 represents data output in a spreadsheet for landmarks of a cow tracked according to x- and y-coordinates within a series of image frames from a video recording, according to an exemplary embodiment;

FIG. 5 depicts an example of a lameness scoring system for assigning a lameness score to an animal, according to an exemplary embodiment;

FIG. 6 is a graph of the movement of a leg of a cow generated from data output by an artificial intelligence model tracking certain body parts in a video recording, according to an exemplary embodiment;

FIG. 7 provides graphs of the fetlock velocity of all four legs of a cow, demonstrating the difference in velocity for a lame leg, according to an exemplary embodiment;

FIGS. 8A-8D provide graphs of back curvature (FIG. 8A), average stride length (FIG. 8B), average near step tracking distance (FIG. 8C), and average far step tracking distance (FIG. 8D) that can be generated from data output from the artificial intelligence model tracking certain body parts in a video recording, according to an exemplary embodiment;

FIG. 9 depicts a posterior view scoring system for identifying lameness in a cow, according to an exemplary embodiment;

FIGS. 10A and 10B depict front and rear views, respectively of force plate sensors for a pressure sensitive mat to determine weight bearing on each leg of an animal, according to an exemplary embodiment;

FIGS. 11A-11C depict graphs of weight-bearing measured using a pressure sensitive mat having a plurality of force plate sensors, according to an exemplary embodiment;

FIG. 12 depicts an embodiment of weights used in a machine learning algorithm, in particular a random forest machine learning algorithm, to identify important parameters of lameness that are used in calculating the lameness score, according to an exemplary embodiment;

FIG. 13 depicts a polynomial regression model comparing the accuracy of the predicted lameness (gait) scores from the machine learning model disclosed herein to actual lameness scores as scored by a human expert;

FIG. 14 depicts screenshots from a mobile application through which recordings of an animal can be uploaded and analyzed by the artificial intelligence model and lameness score obtained, according to an exemplary embodiment; and

FIG. 15 is a flow diagram of a method for utilizing the mobile application to obtain a lameness score for an animal, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Embodiments of the present disclosure address the challenges associated with visual (human) identification of lame animals, in particular cows, in a large herd through the development of farm-deployable technologies that can help farmers, such as dairy producers, monitor the prevalence of lameness in their herds. In this way, follow-up foot care and hoof trimming procedures can be scheduled in a timely manner. The automated lameness identification method and system described herein is convenient, easy-to-use, robust, and mobile-friendly. Farm employees with busy schedules do not have to spend time on desktop web applications, and utilizing the disclosed technology does not present a steep learning curve to such farm employees. In contrast to desktop computers, handheld computing devices, such as smartphones and tablets, are very prevalent on farms. As such, the proposed technology is simple, easy to understand, and deployable on mobile devices so farm employees can quickly access data. These and other aspects and advantages will be described more fully in relation to the embodiments presented below and depicted in the figures. These embodiments are presented by way of illustration and not limitation.

Lame cows are identified based upon abnormal posture or gait parameters from cows with normal posture or gait. There are some obvious parameters to detect a lame foot. For example, during walking, lame cows have smaller stride lengths, and the lame foot has shorter ground contact time. During standing, the lame foot is restless, shaky, and has shorter ground contact time because of pain caused by the lame foot, leading to reduced weight bearing on the lame foot. Additional parameters are discussed more fully below. The disclosed technology involves installing or placing an imaging device at one or more locations around a farm (or other animal facility), recording videos of specific body postures of animals, extracting selected body parameters, making inferences about the lameness condition of each recognizable animal, and generating an ID list of suspected lame animals. For each step, the disclosed method and system is scalable to large-scale farms. As will be discussed below, the technology workflow is categorized into: (1) methods for imaging animals and measuring their weight bearing on four legs, (2) methods to identify animal body structure, (3) methods to quantify lameness or identify potential illness, nutritional deficiency, or need to alter diet or feeding management, and (4) front-end software (e.g., smartphone application) interacting with the user seeking to identify lame or otherwise potentially unhealthy cows.

An imaging device is used to record videos of the animal walking or standing. For reference, the animal is considered to have an anterior side (view looking at the head of the animal), posterior side (view looking at the rear of the animal), a dorsal side (view looking at the top of the animal), a ventral side (view looking at the underside of the animal), a first profile (first side view between anterior side and the posterior side), and a second profile (second side view between the anterior side and the posterior side). In one or more embodiments, the video records at least one of a profile view of the animal, a posterior view of the animal, or an anterior view of the animal. In one or more embodiments, the video recording includes at least the legs of the animal or at least the back of the animal; although, preferably the entire height of the animal is recorded.

The imaging device can be placed in various locations to collect the recordings of these views. In one or more embodiments, the imaging device is a mobile device, in particular a handheld, portable device, such as a camcorder, smartphone, tablet, or digital video recorder, among other possibilities. As used herein, “handheld, portable device” refers to the general size, structure, and weight of the imaging device in that the imaging device is preferably able to be held and operated in the user's hand, although the imaging device may be secured to, e.g., a gimbal stabilizer, tripod, or other mounting device as desired by the user, especially to minimize vibrations during recording. Further, in one or more embodiments, the imaging device may be a permanent installation in communication with a mobile device of a user, such as a permanently mounted camera designed to transmit video recordings to a smartphone over a wireless network (e.g., Wi-Fi, Bluetooth, etc.) or a wired network (e.g., Ethernet, USB, etc.). Additionally, in one or more embodiments, the imaging device is configured to automatically start or stop recording, for example, when software capturing the recording recognizes that an animal has entered/exited the frame or after a sufficient amount of recording has been captured. Still further, in one or more embodiments, the imaging device is secured to rails or gates in the farm facility to securely hold and position the imaging device during recording.

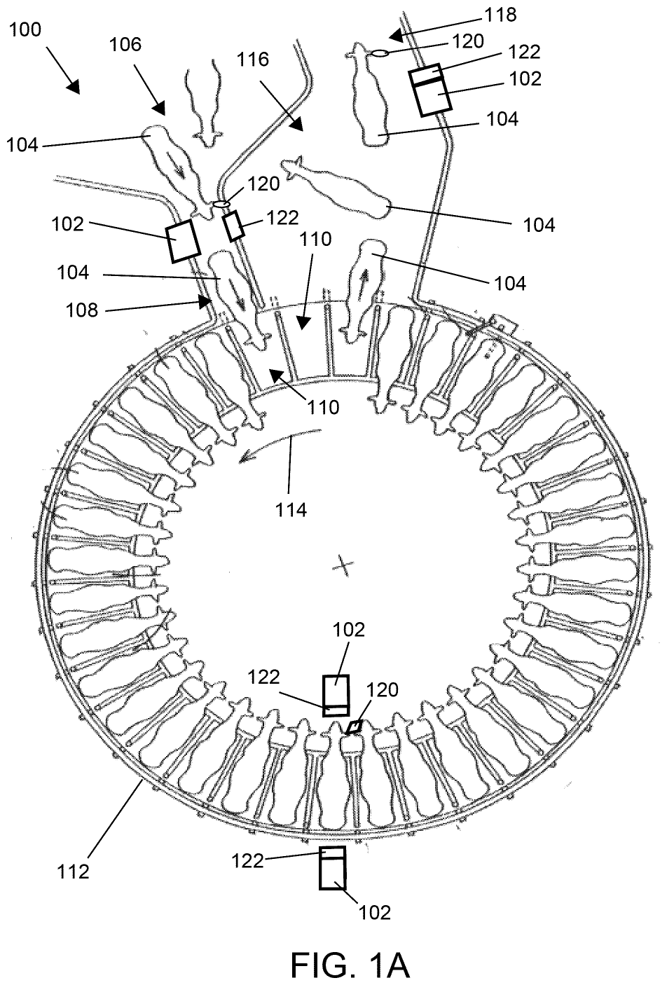

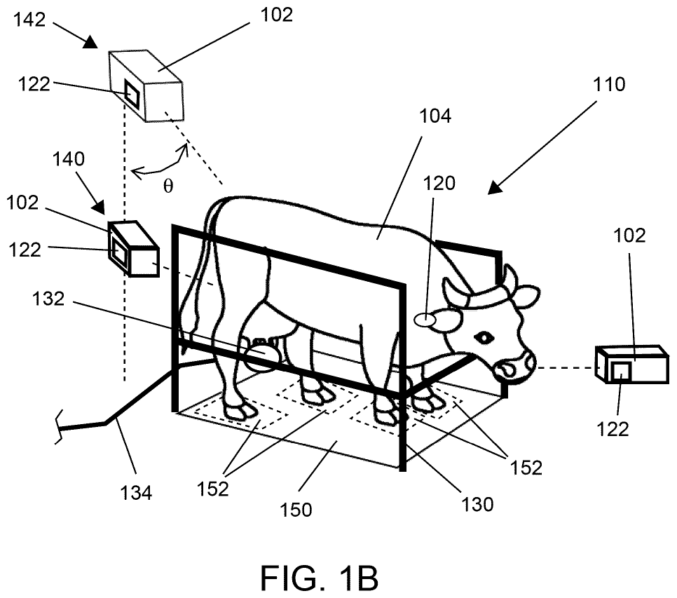

FIG. 1A depicts a schematic representation of a rotary milking parlor 100 including one or more imaging devices 102 for capturing recordings of animals. While a rotary milking parlor 100 is described as an example to illustrate concepts of the disclosure, other milking parlor types should also be considered to be within the scope of the disclosure, such as herringbone, trigon, rapid exit, tandem, abreast, tie stalls, and robotic milking, amongst other possibilities. In the embodiment depicted, the animals are cows 104. As can be seen in FIG. 1A, cows 104 gather in a holding area 106. The holding area 106 tapers into a corridor 108 sized to limit passage to a single cow at a time. That is, the cows 104 cannot pass through the corridor 108 two or more abreast. The corridor 108 leads to a stall 110 on a rotating platform 112. As denoted by arrow 114, the platform 112 rotates (counterclockwise in the embodiment of FIG. 1A) such that different stalls 110 are aligned with the corridor 108. In this way, one cow 104 walking through the corridor 108 can be directed into one stall 110. The platform 112 is rotated, and the next cow 104 walking through the corridor 108 can be directed into the next stall 110. In the stall 110, a milking cluster is connected to the udders of the cow 104. As is known in the art, the milking cluster includes a plurality of teatcups in which each teatcup is attached to an udder, and pulsating suction is drawn through the teatcups to extract milk from each udder, which is collected in a claw in fluid communication with a milk collection line.

The rotary milking parlor 100 allows for cows 104 to continually be loaded onto the platform, milked, and unloaded after the platform 112 has completed its revolution. As can be seen in FIG. 1A, the rotary milking parlor 100 includes an exit area 116 where the cow 104 can be removed from the stall 110, turned around, and directed through an exit passage 118.

In one or more embodiments of the rotary milking parlor 100, at least one imaging device 102 is positioned adjacent to the corridor 108, the exit passage 118, and/or at one or more locations around the platform 112. For example, positioning the imaging device 102 adjacent the corridor 108 and/or the exit passage 118 allows for the capturing of profile views of the cows 108. The exit passage 118 is particularly suitable for capturing profile views of the cows 104 because the cows 104 will be more relaxed after milking. Further, capturing video recordings at these locations in particular allows for single cows 104 to be recorded, avoiding the need to separate and track individual cows in frames of a video recording.

As shown in FIG. 1A, the cows 104 face inwardly towards the center of the platform 112, and by placing imaging devices 102 around the platform 112, recordings of the posterior of the cow 104 can be captured. Similarly, an imaging device 102 disposed on the interior of the platform 112 can allow for capturing of the anterior of the cow 104.

FIG. 1B provides a schematic representation of a milking stall 110 from a perspective view. As can be seen in FIG. 1B, the milking stall 110 includes railings 130 to contain the cow 104, and a milking cluster 132 is attached to the utters of the cow 104 to extract milk. The extracted milk is centrally collected through the collection line 134. The collection line 134 in FIG. 1B is shown trailing out of the stall 110 primarily for the purpose of illustrating the component, but in practice, the collection line 134 would likely drain under the stall 110 or toward the center of the platform 112. In one or more embodiments, the posterior view of the cow 104 is captured from at least one of two positions. The first position 140 of the imaging device 102 is substantially directly behind the cow 104, and the second position 142 of the imaging device 102 is an elevated position aimed downwardly at the tail and hips of the cow. In one or more such embodiments, the imaging device 102 in the second position may be at an angle θ of about 45° to 75° relative to a vertical axis below the imaging device 102. FIG. 1B also depicts the imaging device 102 positioned to capture the anterior view of the cow 104, which is typically positioned substantially directly in front of the cow, preferably such that the full height of the cow 104 from the forehooves to the top of the back is captured.

In one or more embodiments, the cows 104 are tracked as they enter, exit, and are milked on the platform 112. In this way, the side and/or posterior recordings of the cows 104 can easily be associated with individual cows 104. For example, in one or more embodiments as shown in FIG. 1A, each cow 104 is tagged with a tracking device 120, such as an ear tag or collar, that is communicates with a reader 122 positioned, e.g., in at least one or more of the corridor 108, stall 110, or exit passage 118. In one or more embodiments, a reader 122 is positioned adjacent to each imaging device 102 to facilitate associating the captured recording with a particular cow 104. The tracking devices for the cows 104 are not particularly limited, and such tracking devices may operate according to such protocols as RFID (e.g., ISO 11784/11785), near field communication, and Bluetooth Low Energy, among other possibilities. Typically, in dairy operations, cows 104 already have RFID chips in ear tags that are integrated into herd management applications. Additionally or alternatively, image analysis can be used to track individual cows 108. For example, facial recognition of animals, such as cows 104, has been demonstrated in the art. Still further, the cows 104 may be provided with a marking, such as a barcode, QR code, or other unique identifier, that can be read from recording of the cow 104 made by the imaging device 102.

The imaging device 102 placement described herein is merely exemplary, and imaging devices 102 may alternatively or additionally be placed in or adjacent to other areas, such as the loading/unloading dock of the milking parlor, a general pen, a lame animal pen, a hospital pen, a trim chute (for trimming of hooves), or an automated milking robot. Use of the disclosed method and system is particularly suitable for use in farm facilities that utilize automated milking robots. In such facilities, a cow is not directed to a milking parlor, and instead the cow travels to a stall located in a holding building when the cow desires to give milk. An example of a commercially available automated milking robot is the Lely Astronaut A5, available from Lely North America, Inc., Pella, IA. In such circumstances, there are few, if any, people on hand to regularly observe the cows to detect lameness. Accordingly, in a facility employing automated milking robots, increased lameness may be observed. The presently disclosed method and system for detecting lameness using artificial intelligence applied to recordings captured by strategically placed imaging devices is particularly suitable for such robotic milking installations.

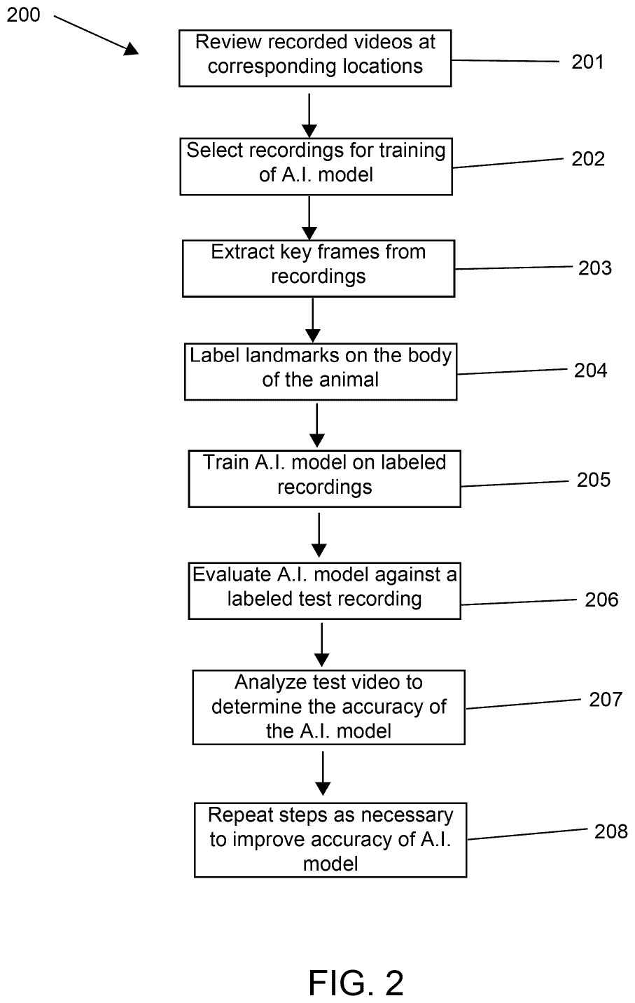

According to embodiments of the present disclosure, the video recordings captured by the imaging device 102 are uploaded to a database and used to train an artificial intelligence model, such as a neural network, to apply to later video recordings for automated identification of lameness. A flow diagram of a method for developing the automated method 200 for identifying lameness is provided in FIG. 2. In one or more embodiments, the method 200 includes a first step 201 of reviewing the recorded videos at corresponding locations (e.g., that capture the cow from the same view). In a second step 202, recordings are selected for training of an artificial intelligence model. In one or more embodiments, the articificial intelligence model utilizes an image analysis model selected from a group comprising a long short-term memory model, a recurrent neural network model, gated recurrent unit, convolutional neural network, transformer networks, autoencoders, multilayer perceptrons, generative adversarial networks, and radial basis function networks. In one or more embodiments, for the purposes of training, recordings that have clear views of the side or posterior of the cow without obstructions may be selected for training. In a third step 203, key frames are extracted from the recordings. In this way, the training does not need to be based on every frame of a recording, which decreases the training time and processing power needed for training.

Applicant has developed a library consisting of over 2,000 video recordings of multiple healthy and lame cows from cattle farms in Indiana, Illinois, and Iowa. The video recordings have a length of between 1 minute to 5 minutes long and were captured at 30 frames per second (fps) with a 1920×1080 pixels resolution. To minimize the memory size of the recordings, Applicant used the High Efficiency Video Coding (HVEC) encoder that is built in common smartphones, such as Android and iPhone devices. Applicant observed that most recordings had consistent image quality and were retained for video processing, while around 10% recordings were deleted due to poor image quality, bad lighting, and/or animal crowding.

Further during the third step 203 of pre-processing the recordings, Applicant converted each input recording into a sequence of JPEG images and down-sampled by a factor of 5 to minimize the number of images to analyze. Because the cow in each recording does not move very fast in one second, this down-sampling allowed Applicant to consider every fifth image per second in the video (recorded at 30 frames per second) while retaining most information about the cow locomotion. For this, Applicant used a clustering algorithm, in particular a k-means clustering algorithm, to select key images where there is a significant change in the cow's position from the previous image. This down-sampling step helped to eliminate redundancy in images and reduce the number of images to analyze. The down-sampling also helps to overcome situations where the cow is not walking continuously, i.e., the cow takes steps intermittently.

The videos were then grouped into training and test datasets. The particular manner of extraction of key frames according to the third step 203 undertaken by Applicant is merely exemplary, and the recordings may be pre-processed in other manners as dictated by the particular application.

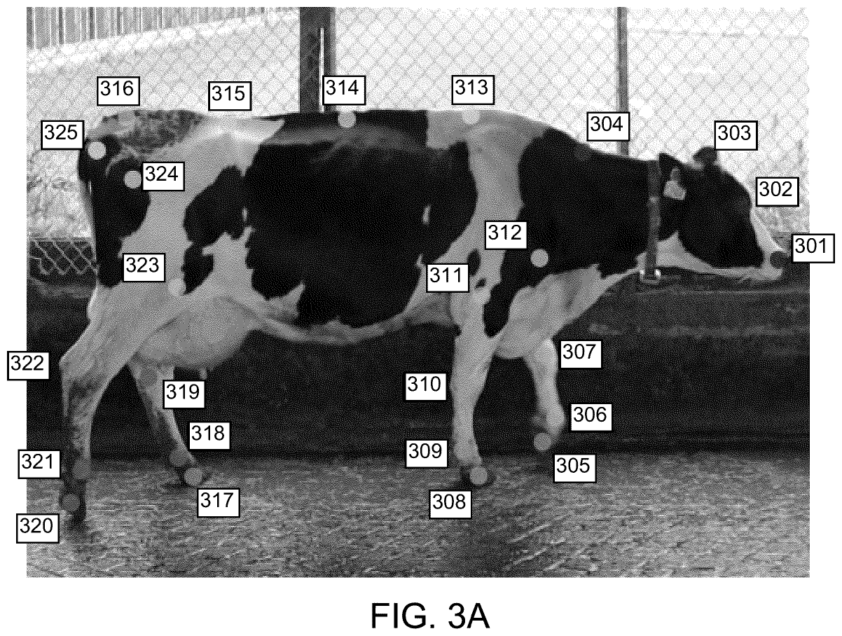

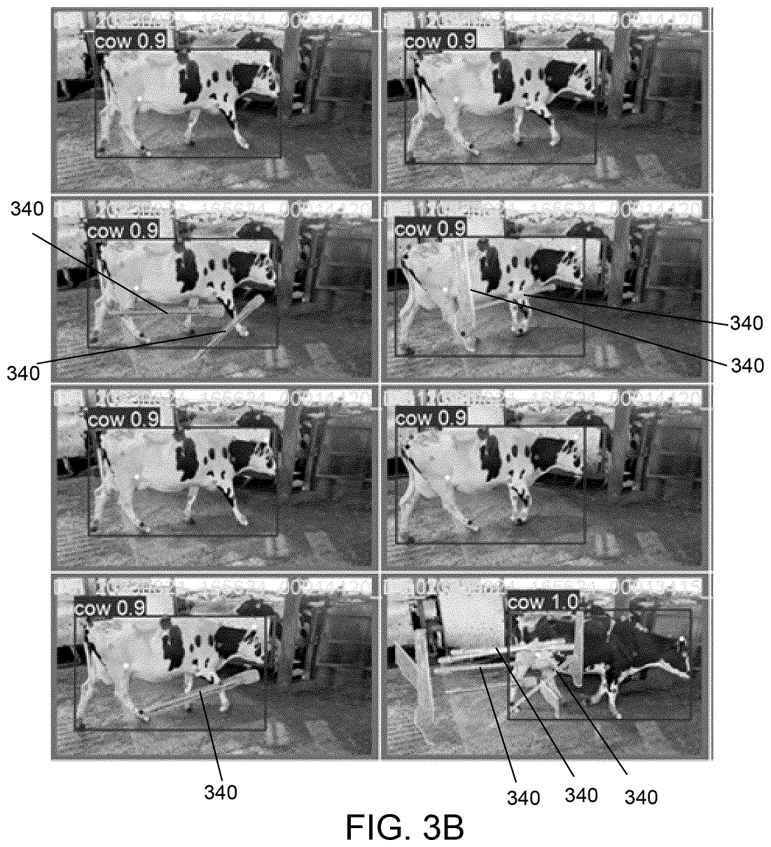

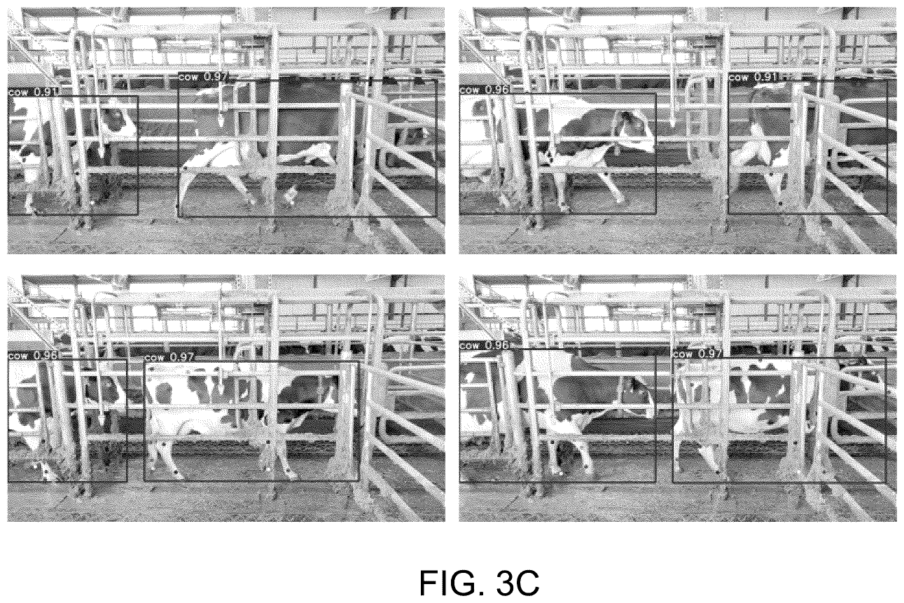

In a fourth step 204, landmarks on the body of the cow in the training dataset are labeled for tracking in the recording. FIG. 3 depicts a side view of a cow 104 showing various landmarks of the cow's body labeled for tracking within the recording. In the embodiment shown in FIG. 3, twenty-five landmarks are labeled: nose 301, eye 302, poll 303, neck 304, far forefoot 305, far forefetlock 306, far foreknee 307, near forefort 308, near forefetlock 309, near foreknee 310, elbow 311, shoulder 312, withers 313, back 314, tuber coxae 315, tailhead 316, far hindhoof 317, far hindfetlock 318, far hindhock 319, near hindhoof 320, near hindfetlock 321, near hindhock 322, stifle 323, hip joint 324, and ischium 325. The landmarks are merely exemplary. In one or more embodiments, only some of these landmarks are tracked, or different landmarks are tracked alternatively or in addition to at least some of the foregoing landmarks. In one or more embodiments, labeling of the landmarks in the recordings is done manually by trained technicians operating on the backend of the system and method.

In the model developed by Applicant, the selected images within the training dataset were labeled with 14 landmarks, and the A.I. model was configured to identify any or all of these 14 landmarks on the cow's body within every selected image of the test dataset.

Returning to the flow diagram of FIG. 2, a fifth step 205 of the method 200 is training the A.I. model on the labeled recordings such that the A.I. model can apply the landmarks to newly uploaded recordings. Any of a variety of A.I. models known in the art can be trained on the labeled recordings. In one or more embodiments, the A.I. model is a neural network. An example of a known neural network suitable for use with the disclosed method and system is EfficientNet B6, which is a convolution neural network (available at https://arxiv.org/abs/1905.11946). However, as discussed above, the A.I. model could instead be selected from among a long short-term memory model, a recurrent neural network model, gated recurrent unit, convolutional neural network, transformer networks, autoencoders, multilayer perceptrons, generative adversarial networks, and radial basis function networks. In a sixth step 206, the A.I. model is evaluated by applying the A.I. model to a test recording such that the A.I. model maps the landmarks to the test video. In one or more embodiments, the A.I. does not need to label every landmark in a recording. For example, lameness may be determined by tracking less than all landmarks, such as a preferred set of landmarks. Further, in the recording, portions of the cow may be obstructed such that only portions of the cow can be labeled. In a seventh step 207, the test video is analyzed to determine the accuracy of the landmarking applied by the neural network. In an eighth step 208, the previous steps can be repeated to build the training set of videos with landmarking to improve the accuracy of the A.I model trained on those videos.

Further, Applicant has identified several ways to improve the accuracy of the A.I. model. In particular, accuracy can be improved according to the method 200 discussed above by such actions as background removal from the recordings, data cleaning of the recordings, and use of synthetic data to enrich the training sets. Referring first to background removal, the raw recordings can be edited by implementing background removal from each image frame using a deep image matting algorithm or another photo editing feature. Background removal can remove undesired images outside the animal under study to improve the model's accuracy, e.g., by removing potentially confusing background matter.

With respect to data cleaning, image frames that are difficult to process by the A.I. model are removed. In one or more embodiments, any image frame having more than one animal (such as one whole and one partial cow, two cows etc.) is excluded. This can be accomplished by watching the number of landmarks of the same type identified by the A.I. model. That is, images with more than one cow will have more than one landmark of a certain type, such as two eyes, two noses, or a partial body.

Further, the pre-processing can involve use of synthetic data. In the library of over 2000 recordings collected by Applicant, there is a limited number of recordings for each lameness score, especially lameness scores for severely lame animals, and additional recordings will improve the performance of the A.I. model. However, until such recordings are collected, synthetic data can be used to re-create the movement of lame cows, thereby increasing the size of the training dataset for the A.I. model. That is, a spreadsheet backfilled with data mimicking a lame cow or a severely lame cow can be fed back into the A.I. model to provide additional data points for training. Additionally, the accuracy is improved by not using image segmentation or bounding boxes to identify body parts in the image frames but instead using the A.I. model to identify body parts, which allows processing of recordings in which the cow is not moving in a straight line.

Still further, synthetic data can also be used to improve detection of body parts. Often, a cow moving through a milking parlor or another environment will be partially obscured by fencing, gates, rails, or other bounding or directing structures. Thus, as shown in FIG. 3B, synthetically added obstructions 340, randomly arranged, can be added to images of cows so that the A.I. model can be trained to identify cow body parts despite the image of the cow being partially occluded, thereby improving robustness of detection when real occlusions or obstructions are present. Thus, as shown in FIG. 3C, the A.I. model is able to detect body parts of cows in real-world situations where there are partial cow bodies, obstructions, and/or occlusions in front of or in the vicinity of the cow. As shown in FIG. 3C, the A.I. model trained on synthetic data, such as shown in FIG. 3B, is able to identify not only full cow bodies but also partial cow bodies with a high degree of confidence. Indeed, where half or more of the cow was present, the A.I. model was able to detect individual cows with greater than 90% confidence. While the synthetic data discussed here related to adding obstructions, the synthetic data could instead represent partial body parts, self-occlusions, multi-animal occlusions, animal-to-background occlusions, interclass or intraclass occlusions, multi-animal crowding effects, or animals having particular lameness scores as discussed above.

Further, other methods can be used to address obstructions, occlusions, or crowding by other animals within a video recording. For example, a landmark can be tracked, and known occlusion handling methods can be employed to predict or estimate the position of the body part hidden by the obstruction, occlusion, or crowding. Additionally, in an example embodiment, the location of the body part of the animal hidden by the obstruction occlusion, or crowding can be approximated using historical data or training datasets. Indeed, missing or undetected body parts in frames of the video recording (e.g., where hidden by an obstruction, occlusion, or crowding) can be estimated using approximations, averaging, regression, or predictions from historical data and training datasets.

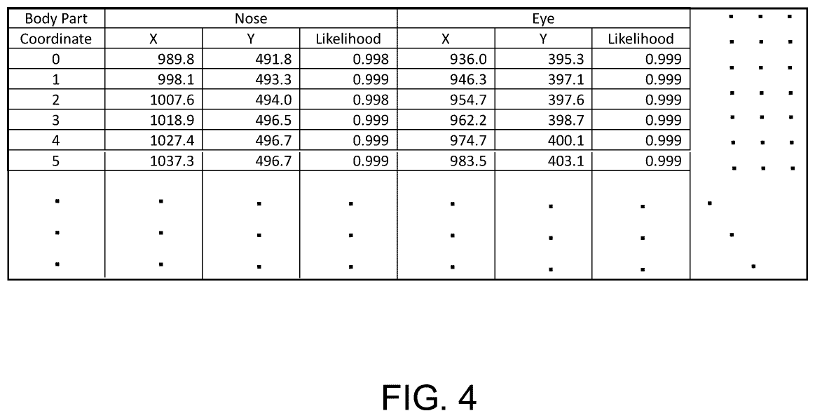

The trained A.I. model can be incorporated into a software package to automatically label new recordings of animals walking or standing. Further, the software can identify in the recordings the relative position, time duration, time shift, angle velocity, and/or acceleration of the labeled body parts. An example of a software architecture that can incorporate the trained model and provide functionality for tracking labeled body parts is TensorFlow.js (https://www.tensorflow.org/), which allows for deploying of the software on mobile devices using javascript language and libraries. FIG. 4 depicts an exemplary output of the software in the form of a spreadsheet of a tracking program that identifies x- and y-coordinates of the tracked body part of a cow within the frame along with the confidence level (“likelihood”) that the A.I. model has correctly identified the tracked body part. As can be seen for the first body part of the cow's nose, the x-coordinate can be seen increasing, which is consistent with the cow moving across the frame. However, the y-coordinate of the nose does not change much, indicating that the cow's head is not bobbing significantly as it moves across the frame. A similar situation is observed for the eye. Both body parts have a high likelihood (>0.998 in each instance), indicating that the A.I. model has high confidence in the tracking of these particular body parts. A similar output would be provided for each labeled and tracked body part.

Based on the x- and y-coordinates, various different parameters associated with the animal's walking can be measured. According to a first example, the near forefoot can be tracked to measure stride length, which is the distance between two consecutive foot strikes of the same limb. According to a second example, each foot can be tracked to determine a time duration of foot contact with the ground. According to a third example, the maximum angle of the foot's swing during stride can be measured. According to a fourth example, the swing rate, swing time, swing distance, step width, tracking-up distance, and stance time of each hoof, fetlock, and/or knee can be measured. According to a fifth example, the animal's head bob can be measured, i.e., head raising or head drooping, which is measured as the distance from the nose to the front foot. According to a sixth example, arching of the back can be measured by measuring the curvature of landmarks on the back of the animal. According to a seventh example, the asymmetry in step length, asymmetry in step time, asymmetry in step width, and asymmetry in stance time can be measured by tracking each foot, fetlock, and/or knee.

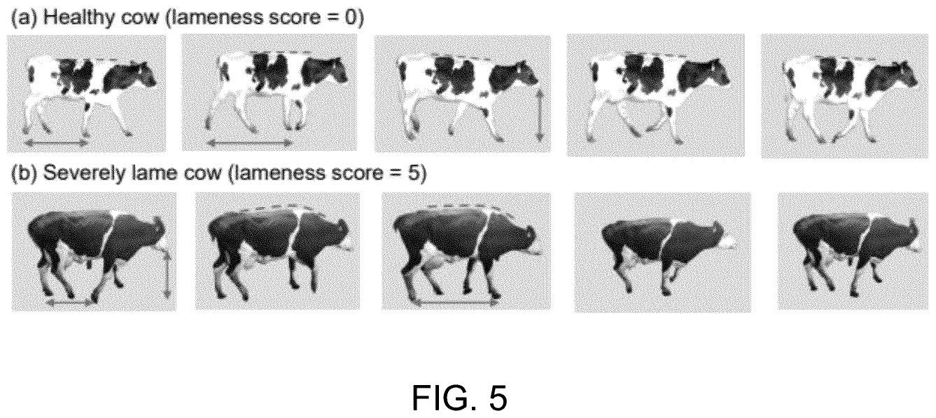

By measuring these gait and posture parameters associated with the animal walking or standing, a relative level of lameness or health can be determined. In the industry, a five-point scale is often used to assess lameness with a score of 0 being associated with a healthy cow, and a score of 5 being associated with a severely lame cow. In general, cows that are lame will exhibit one or more of an abnormal gait, inconsistent stride lengths, head bobbing, and an arched back. FIG. 5 provides a comparison of a first, healthy cow (top row) and a second, lame cow (bottom row). As can be seen in FIG. 5, the health cow has a relatively consistent stride length as compared to the lame cow. Further, the nose position for the healthy cow as it walks is relatively consistent as compared to lame cow, and the lame cow exhibits a much greater arch in its back than the healthy cow. That is, a lame cow has an arching back whereas a healthy cow has a relatively straight back. Other parameters that can be calculated from the labeled and tracked body parts include time duration of contact with the ground for each foot, time duration of non-contact with the ground, posture of the legs, activity of the legs and feet (e.g., shaking of the leg/foot, stomping, stepping, etc.), and other indicators of the animal's reluctance to bear weight on the foot. With respect to the cows depicted in FIG. 5, the walking of the lame cow is influenced by overgrown outer claws.

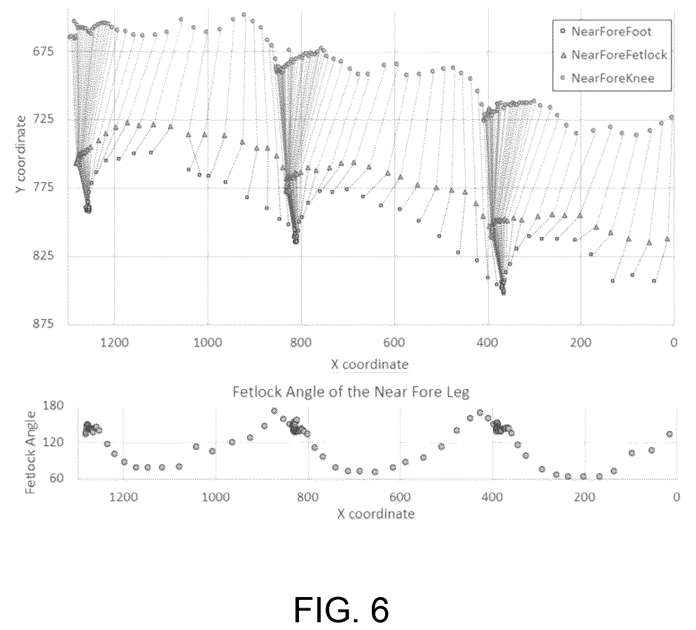

FIG. 6 provides a graph of the parameters as measured and output by the software in the example spreadsheet according to FIG. 4. In particular, the top graph of FIG. 6 depicts the tracked body parts of the near forefoot, near forefetlock, and near foreknee, and when graphed, the movement of the near foreleg can be tracked. From this information, the fetlock angle of the near foreleg can be measured, and the bottom graph of FIG. 6 depicts the change of fetlock angle as the cow walks. Similar graphs could be developed to determine bobbing of the head and arch of the back, amongst other possibilities.

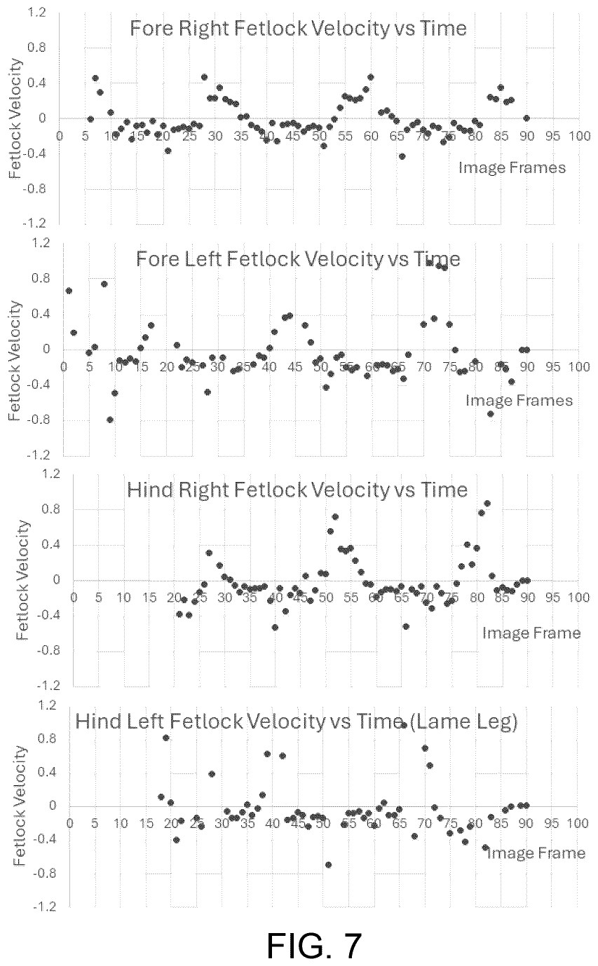

FIG. 7 depicts another set of graphs that can be generated from the data output by the software in the example spreadsheet according to FIG. 4. In FIG. 7, a series of four graphs is presented that represent the fetlock velocity for each leg of the cow as a function of frame in the recording. As can be seen in a comparison of the four graphs, three of the graphs (right fore fetlock, right hind fetlock, and left fore fetlock) have a generally regular periodicity to the velocity of the fetlock, and one graph (left hind fetlock) exhibits abnormal swing phase and stance phase of gait during walking, indicating that the lameness relates to an issue with the left foreleg.

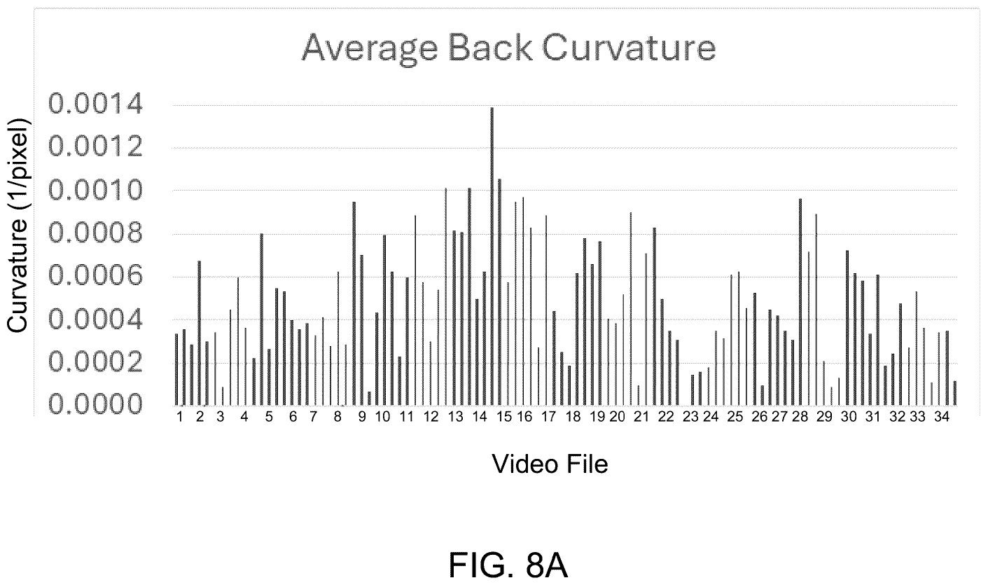

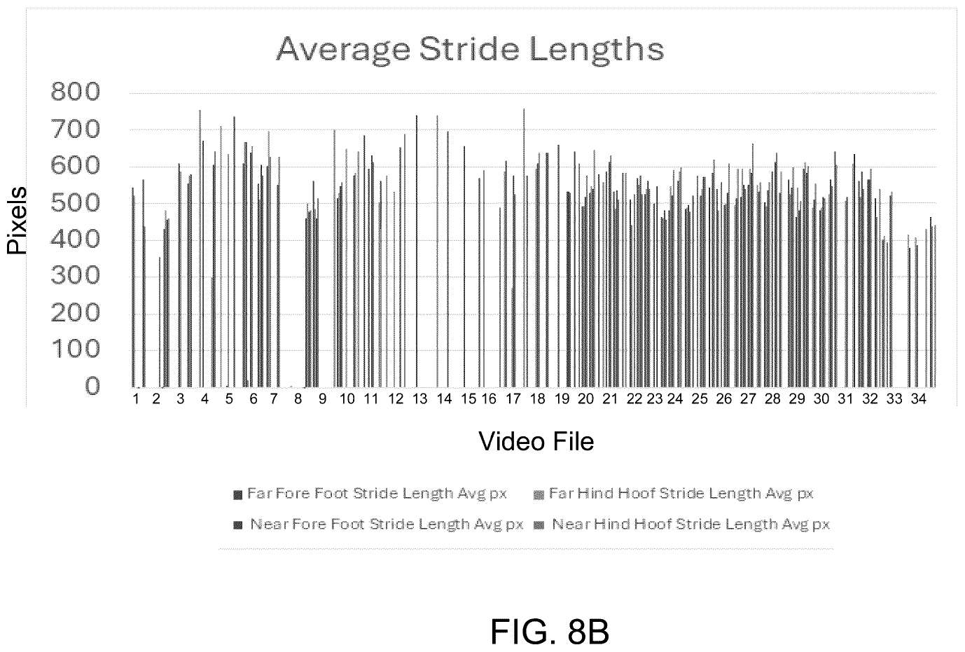

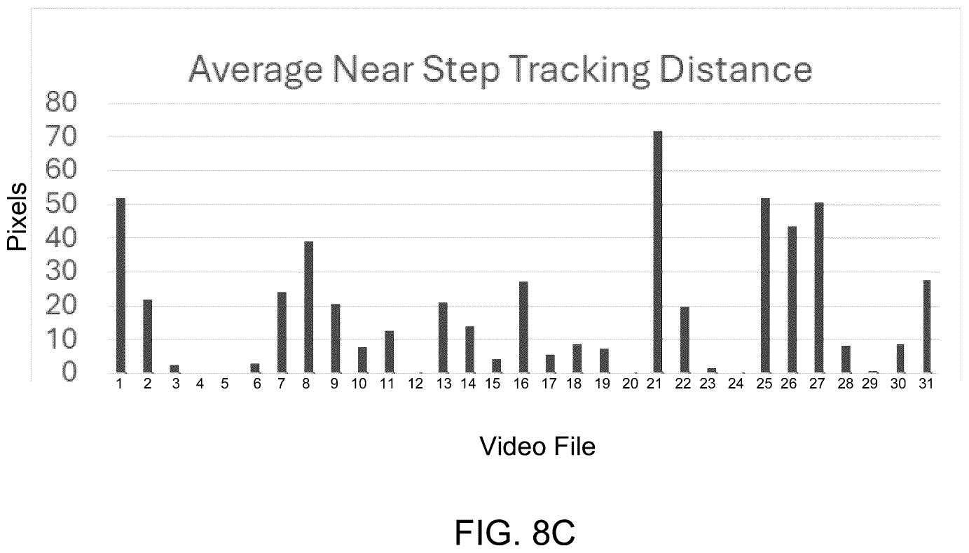

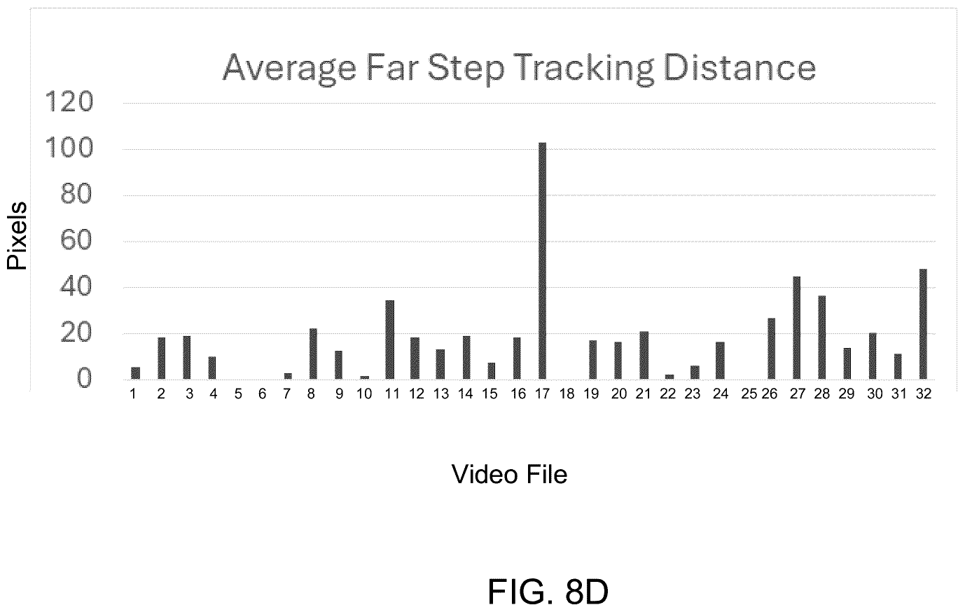

FIGS. 8A-8D depict other graphs that can be generated from the data output by the software in the example spreadsheet according to FIG. 4. In FIG. 8A, the average back curvature of several cows (each cow associated with a video file number). In the video, the curvature of the cow's back was determined by tracking three points along the cow's back (such as withers 313, back 314, and tuber coxae 315 as shown in FIG. 3), and the software calculated the Menger curvature for those three points. As mentioned above, a large curvature in a cow's back or arching of the back is indicative of lameness. Applicant determined that a generally health cow (lameness score of 2 or less) typically exhibited a back curvature of less than 0.0010. A Menger curvature higher than that value indicated lameness of the cow.

The measurements of the curvature (and other measurements discussed herein) were standardized to account for the position of the cow within the recording (e.g., some cows will be closer in the foreground or farther in the background than other cows). As is known in the art, cows within a particular species have a skull in which the distance from the tip of the nose to the top of the head is a constant. Thus, all measurements of pixels within the recordings were normalized based on this constant. Other anatomical distances could also be used to normalize the pixel values, such as distance between tailhead and sternum, distance between the poll and nose, or distance between the poll and eyes, amongst other possible distances between detected body parts.

As shown in FIG. 8B, the average stride length was also calculated for each cow (as represented by the associated video file). From each video file, attempts were made to calculate four stride lengths: far fore foot stride length, far hind hoof stride length, near forefoot stride length, and near hind hoof stride length. As can be seen from the graph in FIG. 8B, all four stride lengths were able to be calculated for several recordings, but for other recordings, less than all four stride lengths were able to be calculated. Lameness can be determined, at least in part, from such a graph by identifying large deviations in stride lengths between each leg.

FIGS. 8C and 8D provide a graph of average step tracking distance for the sides of the cow near to the imaging device and far from the imaging device.

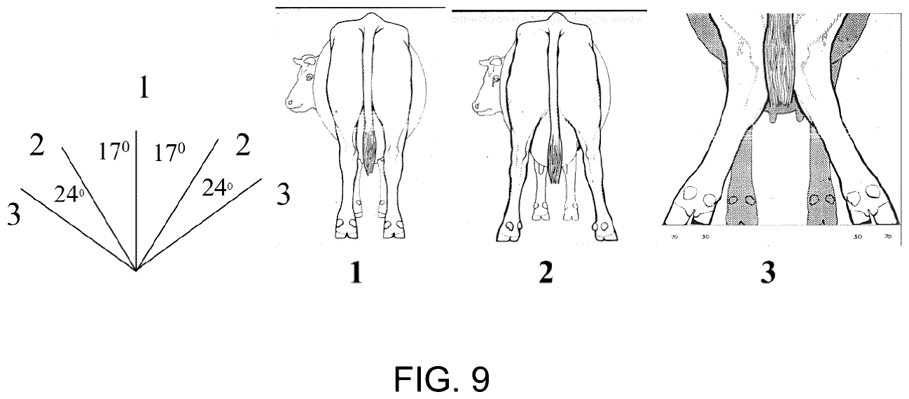

While the foregoing discussion has mostly focused on landmarks and tracking of body parts from the profile view of the animal, the posterior view can also provide information regarding lameness of the cow. As mentioned above in relation to FIG. 1B, recordings of the animal, such as a cow, can be taken from the posterior view from either or both of a position directly behind the animal or elevated above the animal. One advantage of the rotary milking parlor is that one camera can be positioned to record each cow at it passes by on the rotary platform. Nevertheless, in other milking parlor configurations, multiple cameras can be set up to record the cows in a stall, in a plurality of stalls, or in each stall within the parlor, trim chute, or automated milking robot. FIG. 9 depicts a posterior view that could be captured of three cows standing in a milking stall (e.g., from the first position 140 as shown in FIG. 1B). As can be seen in FIG. 9, the cow in the first picture has substantially straight legs that are largely directly underneath the cow such that the feet are aligned with the hips. The cow in the second picture has legs that are slightly splayed out such that the feet are not directly under the hips, and the cow in the third picture has legs that are extremely splayed with the knees knocked inwardly, resulting from overgrown outer claws that cause the feet to define an angled stance relative to the ground. From left to right, the cow in the first picture has the healthiest stance, and the cow in the third picture exhibits lameness. The cow in the second picture is intermediate of the healthy cow and the lame cow. The level of lameness can be characterized according to the angular guide provided on the right side of the figure. As can be seen from the guide, the legs of a healthy cow form an angle of 17° or less. The legs of a lame cow form an angle of 24° or more, and the legs of a cow with some lameness forms an angle of 17° to 24°. The angle is determined from the angle defined by the spine and the interdigital space as is known in the art (see, e.g., E. Toussaint-Raven, et al., “Cattle Footcare and Claw Trimming,” Farming Press, Ipswich, UK (1985), incorporated herein in its entirety by reference thereto).

Using the elevated position (second position 142 shown in FIG. 1B), the imaging device 102 can capture a portion of the spine, tail, and hip fat to determine, e.g., symmetry between the sides of the cow. Significant asymmetry in standing posture and weight bearing on hooves may be indicative of lameness.

The A.I. model as discussed above can be trained to identify landmarks of the posterior view of the animal, such as the left and right hindfeet, left and right hind fetlock, left and right hind hock, left and right hipjoint, and ischium, amongst other possibilities. Once such landmarks are identified, the software can be used to determine the angle defined by the elements of each leg based on their corresponding x- and y-coordinates in the frames of the recording.

Further, from views of the two forefeet and the two forefetlocks, A.I. model can be trained to identify twisted claws or turned up claws based on hoof conformation, which is a critical issue in dairy farms. In particular, the anterior view of the animal can be utilized to check hoof conformation.

In one or more embodiments, such as shown in FIG. 1B, at least one of the stalls 110 in the milking parlor, trim chute, or automated milking robot includes a pressure sensitive mat 150 with force plate sensors 152 configured to determine the relative weight bearing of each foot of the animal, asymmetry in the weight bearing of each foot, total body weight, and/or time duration of weight bearing of each foot. The pressure sensitive mat may be disposed on or be embedded in the floor of the milking parlor, milking robot, or trim cute. If the animal favors one leg or only puts one leg down on the force plate sensors for brief moments of time, then this information can help to identify lameness of one of the legs. Additionally, the force data will provide information about the total body weight of an animal to track the weight loss or body weight fluctuations, if any, when compared to historical data for a particular animal. Body weight loss may be indicative of lameness, illness, nutritional deficiency, or a need to alter the diet or feeding management of the animal. For a cow, losing body weight beyond an accepted range compromises the digital cushion on the foot and makes the leg susceptible to lameness. The force plate data can be considered in conjunction with the posterior view recording and the side view recordings to provide lameness scores from the A.I. model and force plates for an animal.

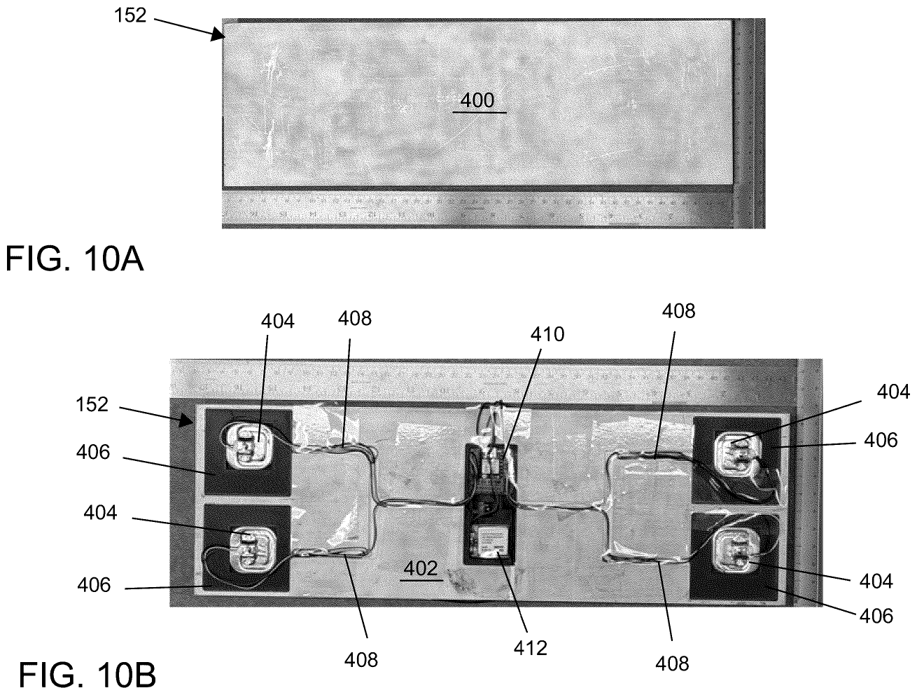

In one configuration, the pressure sensitive mat 150 may include four separate force plate sensors 152 embedded in the pressure sensitive mat 150 to measure how much weight is applied by each of the cow's four feet. In one or more embodiments, the pressure sensitive mat 150 may be approximately 3 feet wide and approximately 6 feet long. An example of a force plate sensor 152 is shown in FIGS. 10A (front view) and 10B (rear view). As can be seen in FIG. 10A, the force plate sensor 152 includes a top surface 400 that is substantially flat, and the animal's foot rests on the top surface 400 of the force plate sensor 152. In one or more embodiments, the force plate sensor 152 includes a rear surface 402 that includes one or more load cells 404, such as four load cells 404 as shown in FIG. 10B. In one or more embodiments, the load cells 404 are held in place by spacers 406. As can be seen, in FIG. 10B, the spacers 406 maintain the position of the load cells 404 and provide a mounting cavity into which the load cells 404 are seated. Additionally, the spacers 406 may provide a lead-out path for electrical wires 408 that connect the load cells 404 to a controller 410, such as a microprocessor, in particular a microprocessor having a data converter for translating the data from the load cells 404 into a format readable by the microprocessor. In one or more embodiments, the load cells 404 and microcontroller 410 may be powered by a battery 412, such as a lithium-ion battery.

As mentioned, the pressure sensitive mat 150 may include up to four force plate sensors 152, one for each leg of the animal. However, in one or more embodiments, the pressure sensitive mat 150 may include less than four force plate sensors 152. For example, because most lameness cases affect the rear legs of cows, the pressure sensitive mat 150 utilizes two force plate sensors 152 to monitor the weight bearing on the rear legs. However, preferred embodiments of the pressure sensitive mat 150 include four force plate sensors 152 to get information on the total body weight and leg strength of the four legs. Further, in one or more embodiments, the pressure sensitive mat 150 may include a communication interface (e.g., Bluetooth, Wi-Fi, NFC, etc.) to export data to a nearby edge device.

Capturing the posterior view (directly behind and/or elevated), the anterior view, and/or the pressure/weight data may be particularly suitable for robotic milking installations, such as those by Lely Robotics LLC. As mentioned above, in such installations, there are not as many people to directly observe lameness or body weight fluctuations, and the cows are not directed into milking stalls for milking. Instead, the cows may wander around and eventually wind up in a milking stall. Because of the lack of direction, there may not be a position from which to regularly capture profile views of the animal. However, when the animal enters the milking stall, the animal will be stationary for a period of time (typically five to eight minutes) while milk is extracted. Thus, the data gathered from the posterior view, anterior view, and pressure sensitive mat may be the best data available to evaluate lameness, leg strength, and body weight fluctuations for animals at a robotic milking installation.

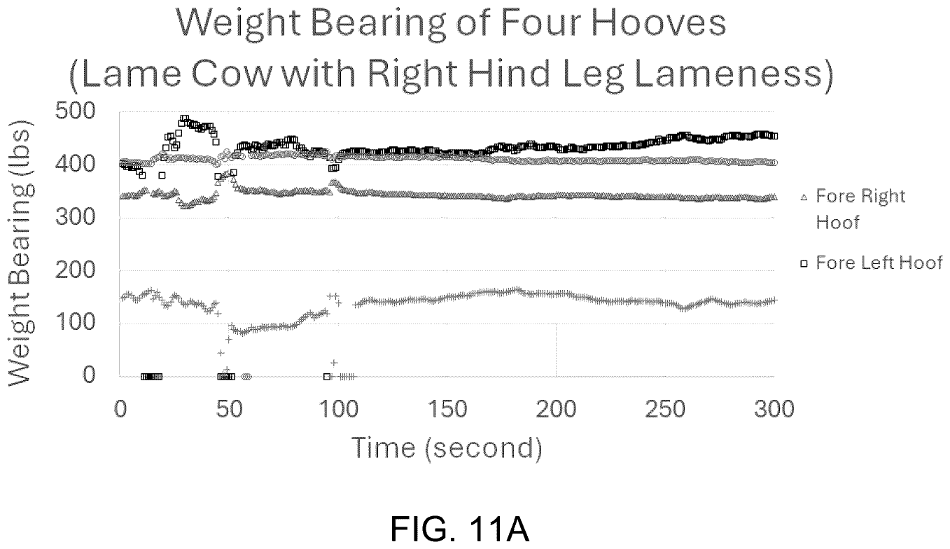

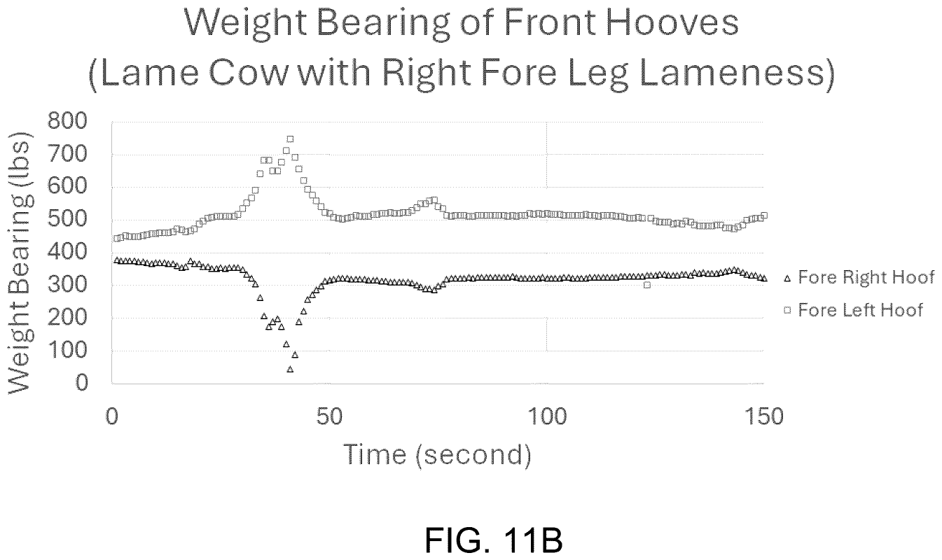

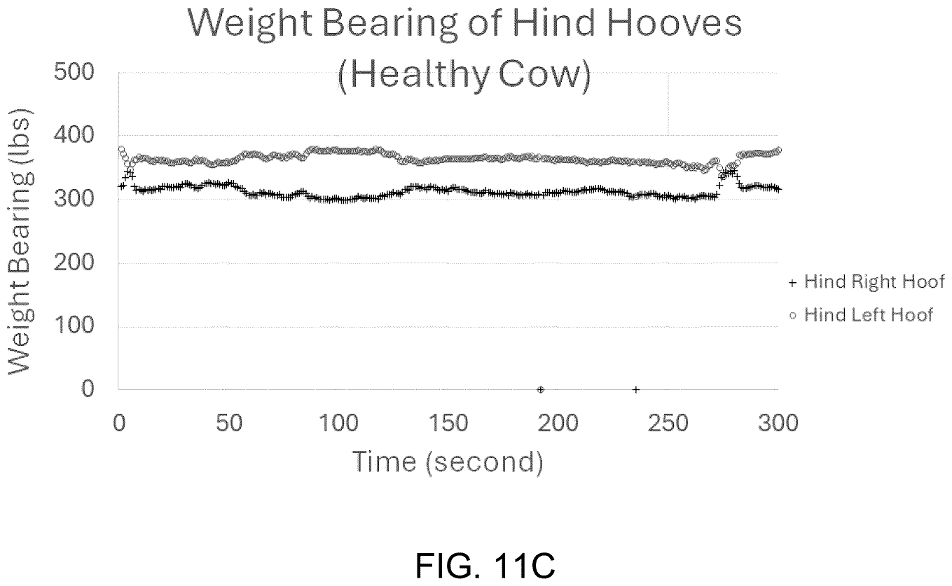

FIGS. 11A-11C depict graphs of weight-bearing measured using a pressure sensitive mat 150 having a plurality of force plate sensors 152 as described above. In FIG. 11A, four force plate sensors 152 were used to measure the weight bearing of the four individual hooves of a standing cow in a trim chute. As can be seen from the graph, three of the four legs bear roughly equal weight, and one leg bears substantially less weight. In particular, from this data, it was determined that the right hind leg of the cow was lame. From the graph, the total body weight of the cow could be determined by adding together the weight that each leg was bearing.

FIG. 11B depicts a graph of the weight bearing on the two fore hooves of a cow. As can be seen from the steady-state standing of the cow, e.g., between about 80 seconds and 120 seconds, the difference in weight bearing is about 100 lbs. In one or more embodiments, a leg is judged to be lame if it bears at least 50 lbs less than the corresponding fore or hind leg. By contrast FIG. 11C depicts two hind legs of a healthy cow, and as can be seen, the left and right legs bear substantially the same weight, in particular the difference between weight bearing on each leg is less than 50 lbs.

By training the A.I. model to identify and label landmarks as discussed above and by using the A.I. model to track relevant parameters associated with the labeled landmarks, the software in one or more embodiments is configured to assign a lameness score to the animal based on a video recording of the animal walking or standing and/or based on the weight bearing of each leg on the pressure mat during standing. In this regard, the gait parameters, posture parameters, and locomotion scores are used as a proxy for lameness for identification. Based, e.g., on the degree of curvature measured along the back of the cow, the bobbing of the cow's head, and/or identified problems with one or more legs of the cow, a lameness store can be assigned to the cow using, e.g., the 0 to 5 scale described above (although, other lameness scoring metrics can also be used as desired) by the A.I. model.

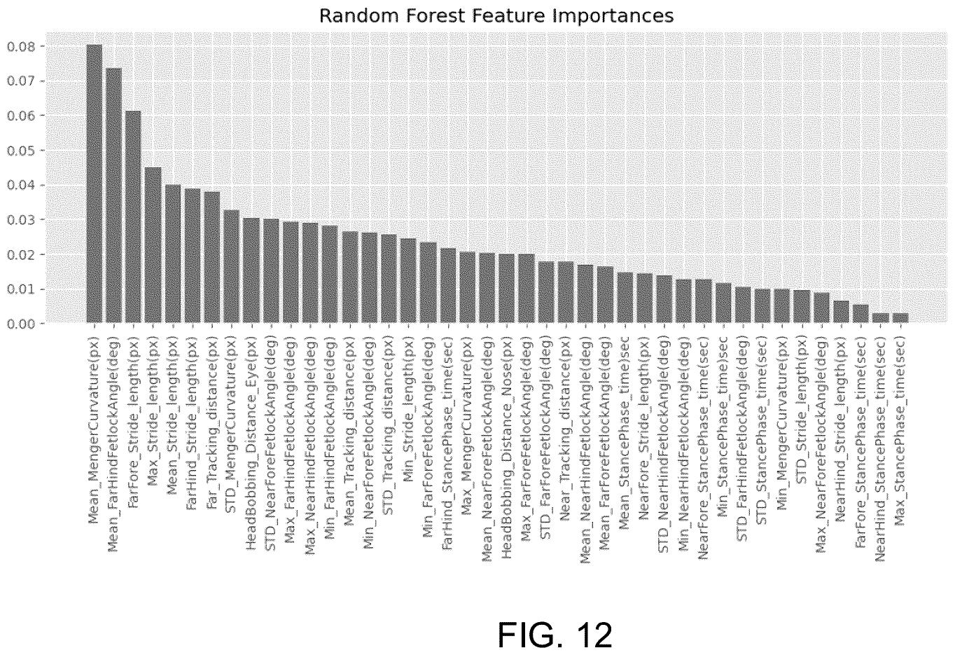

FIG. 12 depicts an embodiment of weights used by the A.I. model, in particular a machine learning algorithm, such as a random forest machine learning algorithm, to identify important parameters of lameness that are used in calculating the lameness score. In one or more embodiments, the highest weighted parameter is the mean of the calculated Menger curvature of the animal's back followed by the mean of the far hind fetlock angle, the far fore stride length, max stride length, mean stride length, far hind stride length, far tracking distance, standard deviation of calculated Menger curvature, headbobbing distance as measured from identified eye feature, and so on as provided in FIG. 12. In one or more embodiments, the highest weight is about 0.08 for the mean calculated Menger curvature, and the weights of each subsequent feature decrease as shown in FIG. 12. Other machine learning algorithms can also be used, such as a linear regression, a logistic regression, a decision tree, a support vector machine, or a naïve Bayes classifier.

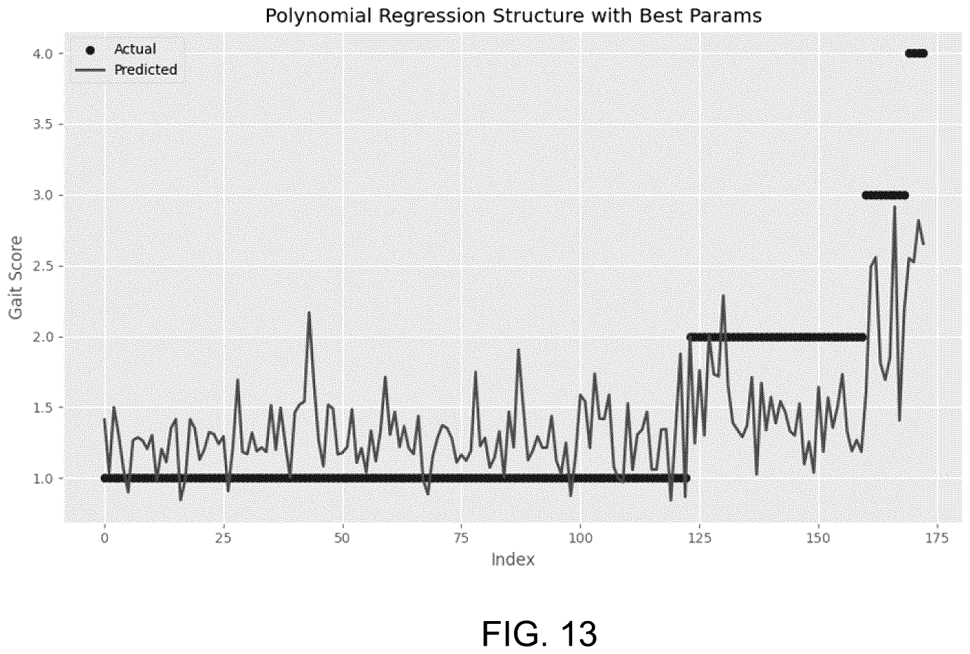

Using the weighted parameters from the machine learning algorithm of the A.I. model, the lameness score is calculated. In one or more embodiments, the accuracy of the lameness score is compared using a polynomial regression model to the lameness score obtained from a human expert as shown in FIG. 13. As can be seen there, the actual lameness score recorded by the expert is shown along the blue line with a corresponding lameness score obtained from the A.I. model. The expert's score is confined to whole numbers, whereas the A.I. model score can be any calculated value. As can be seen, the A.I. model tracks the expert's scoring well, such that the rounded A.I. model score often overlaps with the expert's score (e.g., a score below 1.5 rounds to 1 and a score of 1.5 or greater rounds to 2). In the video library used to develop the lameness core, most of the cows had a lameness score of 1 or 2 as shown in FIG. 13, and there were not many cows having a lameness of 3 or higher. Thus, the model can be improved as more videos are collected of cows have a wider array of lameness.

In one or more embodiments, cows (as identified by its unique ID) with lameness scores of 3 and above can be saved to a computing device and communicated to the farm personnel. Further, in one or more embodiments, all of the calculations of multiple parameters can be performed at the backend to generate the IDs of lame cows, lameness scores of all cows monitored, and/or the average lameness score of the herd on a daily, weekly, monthly, or annual basis. Such data can be plotted and tracked on spreadsheets and graphs to understand trends over time.

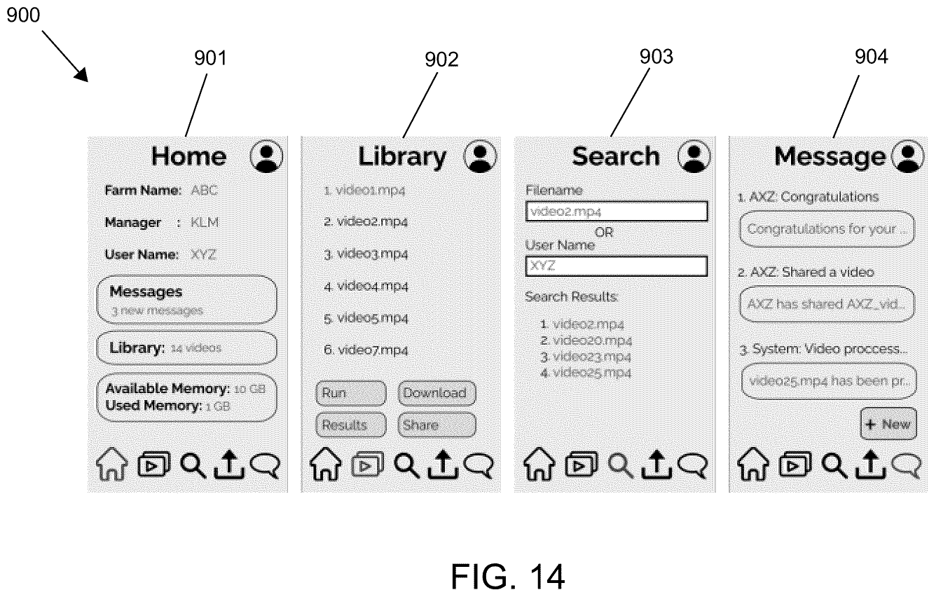

A user can obtain the lameness score through a mobile application 900, an example of which is provided in screenshots shown in FIG. 14. As alluded to above, Applicant deployed the mobile application 900 by converting the pre-trained model to TensorFlow.js and applied quantization to reduce the model size by decreasing the default 32-bit precision to 16-bit precision. The inference time did not change significantly in the 16-bit model after quantization. Further, because the hardware and storage capacity on a user's mobile device is limited, Applicant developed a web-based mobile application having a temporary repository to load the A.I. model file. The front end user interface was developed using FastAPI to access the web-based application and React to create the user interface.

In one or more embodiments, the mobile application 900 includes a home screen 901 including user information, such as the farm name, manager, and username. Additionally, the home screen 901 may include summary information, including such information as number of application messages, number of recordings in the user's library, and available memory. This layout and information are merely exemplary, and the home screen 901 can include other layouts and/or information as desired by the developer.

In one or more embodiments, the mobile application 900 includes a library screen 902 including a directory of the user's recordings (taken by the user or shared with the user) that have been uploaded to the mobile application 900. In the embodiment depicted, the library screen 902 includes commands, such as “Run,” “Download,” “Results,” and “Share.” In one or more embodiments, the “Run” command applies the trained A.I. model to the selected recording and extract a predetermined number of key points (such as 3) and a lameness score for each tracked cow. In one or more embodiments, the “Download” command allows the user to download the recording and related data files from the mobile application 900, e.g., from a server hosting the mobile application, to a selected file location. In one or more embodiments, the “Results” command allows the users to view desired sections of a recording, provides the lameness score for a selected recording, and may output a herd-level analysis of lameness, and in one or more embodiments, the “Share” command allows for the recording to be sent to another user, e.g., in the user's group on the mobile application, to any users on the mobile application, or to third parties on another mobile application. Again, this layout and information is merely exemplary, and the library screen 902 can include other layouts and/or information as desired by the developer.

In one or more embodiments, the mobile application 900 includes a search screen 903 that allows for recordings to be searched for based on the filename or the user that uploaded the recording. As with the other screens, this layout and information is merely exemplary, and the search screen 903 can include other layouts and/or information as desired by the developer.

In one or more embodiments, the mobile application 900 also includes a message screen 904 through which application notifications or messages from other users can be viewed and through which messages to other users can be sent. This layout and information is merely exemplary, and the message screen 904 can include other layouts and/or information as desired by the developer.

Further, as can be seen in the embodiment of FIG. 14, the mobile application 900 includes navigation buttons at the bottom of each page to provide navigation between pages and also to upload a recording.

In the embodiment depicted, the mobile application 900 is designed to have a relatively simple user interface, allowing for ease of navigation with one hand. As discussed above, the user can set up the imaging device running the mobile application 900 or in communication with the mobile application 900 at select locations in the farm. For example, the mobile application 900 may be a smartphone app, the software of which is installed with a pre-trained A.I. (e.g., deep learning) model to identify lame cows.

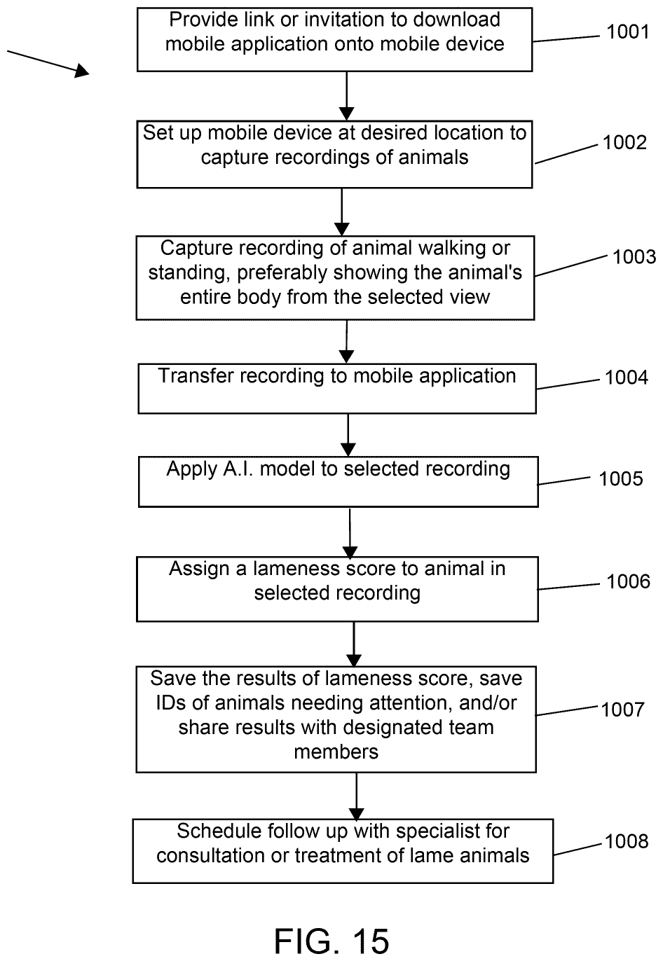

FIG. 15 provides a flow diagram of a method 1000 for accessing and utilizing the mobile application 900. In one or more embodiments, in a first step 1001, the mobile application 900 in the form of a smartphone app is provided to the selected user with instructions to download the software on their mobile device, such as a smartphone. In one or more embodiments, the method 1000 includes a second step 1002 of setting up the imaging device at a designated location to capture recordings of animals walking. To set up the mobile device, the mobile device may be attached to a gimbal stabilizer or mounted to a fixture in the milking parlor or barn (such as a post or railing). In one or more embodiments, the method 1000 includes a third step 1003 of capturing a recording of animals walking or standing using the imaging device (such as a camera on the smartphone or device in communication with a smartphone). Preferably, the recording captures the entire body of the animal from the selected view (e.g., profile view, anterior view, and/or posterior view). In the third step 1003, the captured recordings are saved, e.g., saved locally on the mobile device. Thereafter, in a fourth step 1004, the recording is transferred to the mobile application 900, such as by uploading the recording to a designated library of the mobile application 900.

In a fifth step 1005, the A.I. model is applied to a selected recording, and in a sixth step 1006, the mobile application 900 assigns a lameness score to the animal in the recording. As part of the analysis of the A.I. model, additional data may be generated, such as the graphs and spreadsheet discussed above and shown in FIGS. 4, 6, 7, and 8A-8D. In a seventh step 1007, the user has the option to save the results of lameness scores of cows tracked in the video, save IDs of lame animals needing attention, and share the results with designated team members. Using that information, in an eighth step 1008, consultation and medical follow-ups can be scheduled for treatment of lame animals as needed. In one or more embodiments, such consultations and medical follow-ups can be facilitated through the application. For example, a veterinarian, hoof trimmer, or other specialist can share access with users of the mobile application 900, or the mobile application may be able to recommend specialists in the area that can assist with the particular lameness identified by the mobile application 900.

The final output of the mobile application 900 can be used for record-keeping, welfare assessment, and farm audits. Welfare standards are often required, for example, by dairy cooperatives and processors. The output results generated by the disclosed technology can help dairy farms with their internal audits of welfare standards. Further, the generated output can track the number of cows in the lame pen or the hospital pen, track the daily progression of lameness of specific cows, or track the daily recovery of specific cows after treatment. The disclosed technology can also help with decisions with regards to fitness for travel. Transportation of lame cows is not desired for welfare concerns as it causes stress on the lame cows.

These advantages are realized in a relatively simple and easily deployable mobile application. A recent survey found that 93% of dairy farmers used smartphones, and 61% of dairy farmers already use some form of a farm management app to track the daily feed intake, disease conditions, animal performance, and farm economics (e.g., DairyComp available from Valley Agricultural Software, Visalia, CA). Further, while the foregoing discussion has been presented in terms of dairy cattle for which the disclosed technology is particularly suitable, the teachings can be extended to other animals, such as beef cattle, pigs, sheep, goats, and horses. Indeed, lameness affects all farm animals and is a leading reason for culling animals and resulting economic loss.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for evaluating lameness of animals, the system comprising:
one or more imaging devices, each imaging device configured to capture a recording of an animal walking or standing from a profile view, an anterior view, or a posterior view;
a computing device in communication with the one or more imaging devices, the computing device configured to access an artificial intelligence model to analyze the recording to assign a lameness score to the animal;
wherein the computing device outputs the lameness score to a user.

2. The system of claim 1, wherein the artificial intelligence model identifies body parts of the animal in the recording and determines, based on movement of one or more of the identified body parts, at least one of a gait parameter of the animal walking or a posture parameter of the animal walking or standing;
wherein the artificial intelligence model assigns the lameness score to the animal based on at least one of the gait parameter or the posture parameter.

3. The system of claim 1, wherein the one or more imaging devices comprise a first imaging device and a second imaging device, wherein the first imaging device is positioned to capture recordings of animals walking from the profile view and the second imaging device is positioned to capture recordings of animals standing from a posterior view.

4. The system of claim 3, wherein the one or more imaging devices further comprise a third imaging device and wherein the third imaging device is positioned to capture recordings of animals standing from an anterior view.

5. The system of claim 1, wherein the one or more imaging devices comprise an imaging device positioned above the animal and angled downwardly to capture a recording of an animal standing from a posterior view.

6. The system of claim 1, further comprising a tracker reader configured to detect a wireless tracker on each animal, wherein the tracker reader communicates a unique identifier associated with each respective animal that passes the tracker reader to the computing device, and wherein the computing device associates the recording with the respective animal and the lameness score assigned to the respective animal.

7. The system of claim 1, further comprising a pressure-sensing mat, wherein the pressure-sensing mat is configured to measure pressure applied by each leg of the animal on the pressure-sensing mat and wherein the artificial intelligence model assigns the lameness score to the animal also based at least in part on the pressure measured by the pressure-sensing mat.

8. The system of claim 7, wherein the pressure-sensing mat comprises at least two force plate sensors to measure weight bearing of at least two legs of the animal, the at least two legs being at least hindlegs or at least forelegs of the animal.

9. The system of claim 8, wherein the at least two force plate sensors is four force plate sensors to measure weight bearing of all legs of the animal and a total body weight of the animal.

10. The system of claim 9, wherein, based on changes in weight bearing on the legs of the animal from historical data for that animal, the artificial intelligence model predicts lameness, signs of illness or nutritional deficiencies, or need to alter diet or feeding management of the animal.

11. The system of claim 7, wherein the pressure-sensing mat is disposed on or embedded in a floor of a rotary parlor, a milking robot, or a trim chute.

12. The system of claim 1, further comprising a mobile device, wherein the mobile device comprises the one or more imaging devices and the computing device.

13. The system of claim 12, wherein the mobile device is a smartphone.

14. The system of claim 1, wherein the artificial intelligence model comprises a deep learning model selected from a group comprising a long short-term memory model, a recurrent neural network model, gated recurrent unit, convolutional neural network, transformer networks, autoencoders, multilayer perceptrons, generative adversarial networks, and radial basis function networks.

15. The system of claim 1, wherein the artificial intelligence model comprises a machine learning algorithm selected from a group comprising a random forest model, a linear regression, a logistic regression, a decision tree, a support vector machine, or a naïve Bayes classifier.

16. A method for identifying lameness in an animal, the method comprising:
obtaining a video recording of an animal walking or standing, the video capturing a profile view, a posterior view, or an anterior view of the animal;
analyzing the video recording using an artificial intelligence model to identify a plurality of body parts of the animal;
tracking one or more of the plurality of body parts of the animal over a length of the video recording so as to compute a position of each of the one or more of the plurality of body parts in each frame of the video recording;
calculating at least one of a gait parameter or a posture parameter based on the tracking of the one or more of the plurality of body parts; and
assigning a lameness score to the animal based on at least one of the gait parameter or the posture parameter.

17. The method of claim 16, wherein the video recording comprises a profile view of the animal;
wherein the tracking comprises tracking a nose or eye of the animal; and
wherein calculating further comprises calculating the gait parameter, the gait parameter being head bobbing.

18. The method of claim 16, wherein the video recording comprises a profile view of the animal;
wherein the tracking comprises tracking at least one of a foot, a fetlock, a back, or a knee of at least one leg of the animal; and
wherein calculating further comprises calculating the gait parameter of at least one of an angle or a velocity of the at least one of the foot, the fetlock, the back, or the knee.

19. The method of claim 16, wherein the video recording comprises a posterior view of the animal;
wherein the tracking comprises tracking of a foot, fetlock, and knee of each leg of the animal; and
wherein calculating further comprises calculating the posture parameter of at least one of a leg angle, a hoof conformation, or a claw conformation.

20. The method of claim 16, wherein the video recording of the animal walking or standing comprises one or more of an occlusion, an obstruction, or crowding in front of the animal;
wherein the tracking comprises (i) tracking, using an occlusion handling method, a body part of the animal at least partially hidden by the occlusion, the obstruction, or the crowding or (ii) approximating a location of a body part of the animal at least partially hidden by the occlusion, the obstruction, or the crowding based on previous data or training datasets.

21. The method of claim 16, wherein tracking further comprises generating a spreadsheet containing x- and y-coordinates of the position of each of the one or more of the plurality of body parts with each frame and outputting a graph plotting the x- and y-coordinates for a series of frames.

22. The method of claim 16, wherein tracking further comprises tracking missing or undetected body parts in frames of the video recording using at least one of approximations, averaging, regression, or predictions using historical data and training datasets.

23. The method of claim 16, wherein tracking further comprises normalization techniques to convert a pixel distance to actual distance based on known anatomical distances between specific body parts.

24. The method of claim 16, further comprising pre-processing the video recording after obtaining and before analyzing, wherein pre-processing down samples the video recording to select less than half the frames of the video recording.

25. The method of claim 24, wherein the pre-processing involves using a clustering algorithm to select images where the animal makes a significant change in position.

26. The method of claim 16, further comprising removing background around the animal from the video recording after obtaining and before analyzing.

27. The method of claim 16, further comprising cleaning the video recording by removing any frame in which at least one of the following is present: (i) more than one animal is present in the recording, (ii) multiple animals are crowded together, or (iii) an occlusion or obstruction hides a body part of the animal.

28. The method of claim 16, further comprising training the artificial intelligence model using synthetic data representing partial body parts of the animal, self-occlusions, multi-animal occlusions, animal-to-background occlusions, interclass or intraclass occlusions, multi-animal crowding effects, or animals having particular lameness scores.

29. The method of claim 16, further comprising determining at least one of a leg strength or a total body weight of the animal using (i) at least one of the gait parameter or the posture parameter and (ii) a pressure-sensing mat configured to determine weight bearing on each leg of the animal.

30. The method of claim 29, wherein the weight bearing, the leg strength, and the total body weight of the animal are used in assigning the lameness score.

31. A non-transitory, machine-readable storage medium for a mobile device, the mobile device comprising memory and a processor, the memory configured to store program code and the processor configured to execute the program code to perform a method for identifying lameness in an animal according to the method of claim 16.
